(19) United States
(12) Patent Application Publication
(10) Pub. No.: US 2023/0120919 A1
(43) Pub. Date: Apr. 20, 2023

(54) FECES HOLDER CONFIGURED FOR RELEASABLE ATTACHMENT TO A DOG LEASH AND METHOD OF USE

(71) Applicant: Maria CAPPUCCITTI, Fort McMurray (CA)

(72) Inventor: Maria CAPPUCCITTI, Fort McMurray (CA)

(21) Appl. No.: 17/966,271

(22) Filed: Oct. 14, 2022

Related U.S. Application Data
(60) Provisional application No. 63/256,003, filed on Oct. 15, 2021.

(51) Int. Cl. A01K 23/00; A01K 27/00

(52) U.S. Cl. CPC A01K 23/005; A01K 27/008

(57) ABSTRACT

Embodiments of the invention as described relate to containment and transport of bagged dog feces to a place for disposal. Transporting dog feces is an unpleasant task and the embodiments described herein relate to a discrete and easy to use holder that attaches to the handle of a dog leash. The embodiments of holders are designed and configured for easy attachment and removal from a dog leash. The holders can be releasably secured to the handle of a dog leash at any desired distance for the leash handle. The holders typically comprise opposing convex sides that come together to form a solid base and top, and have perforated sides for ventilation.

This application claims benefit of U.S. provisional application 63/256,003.

### FIELD OF THE INVENTION

The present invention relates generally to the field of detachable holders, specifically to detachable holders that can be attached to dog leashes, more specifically to detachable holders that are configured to attach to a dog leash and hold a bag that contains dog feces.

### BACKGROUND

Any discussion of the related art throughout the specification should in no way be considered as an admission that such related art is widely known or forms part of common general knowledge in the field.

US20120234251A1 discloses a receptacle for receiving containers of feces, for transport therein to a secondary receptacle such as a trash container. The receptacle includes a spring loaded opening, such that the opening may be held open without intervention of a person, and closed after receipt of a feces container therein. The opening may be opened under the influence of energy stored in the coil spring, such that the container(s) of feces therein may fall therefrom under the influence of gravity into the secondary receptacle. A pouch, formed on the exterior of the receptacle, may be configured to carry one or more containers for retrieval of feces there into. Shortcomings include attachment straps that may not universally attach to any leash, as well as a drawstring opening for a slower release of bagged feces.

U.S. Pat. No. 6,257,473B1 discloses a sanitary pet-waste collection pouch including an interior open-topped chamber for holding tied loaded plastic bags containing retrieved pet-waste, the pouch having a flap portion carrying interior and exterior opening pockets on opposite sides thereof, a pair of deep side-pockets on opposite sides of the chamber, releasable retaining loops coupled to the respective deep side-pockets, the interior opening pocket carrying a supply of plastic litter bags and the exterior opening pocket carrying personal effects, releasable retainer loops coupled to the deep side-pockets and each formed of a strip carrying opposite sided “hook” and “pile” portions which are engaged to form the loop, “hook” and “pile” portions being self-engageable forming the loops, and pockets on opposite sides thereof. The flap portion carries a horizontal “hook” portion and is fitted over the open interior chamber and engages a “pile” portion applied to the outer wall of the pouch at a location angular to the “hook” portion, the engagement being adjustable at any location along the length of said “pile” portion dependent upon the girth of the pouch. Shortcomings include attachment straps that may not universally attach to any leash, as well as a drawstring opening for a slower release of bagged feces. Further, attachment straps are not easily accessible as they are located by the dog's collar, rather than at the leash handle.

U.S. Pat. No. 6,085,695 discloses a pet leash bag that is attachable to a pet leash for carrying or holding articles such as pet waste disposal bags, other pet accessories or toys and personal articles of the pet owner. The bag can be fabricated from many different materials and has many embodiments including single or multi-compartment bags, bags with internal and external pockets and bags of different dimensions and size. Shortcomings include a leash bag that is not easily accessible.

U.S. Pat. No. 6,035,809A discloses a leash pouch for containing disposable bags and animal waste when walking animals. The leash pouch attaches to a leash using a mounting device to free the pet owner's hands. A disposable bag compartment is on the first side of the pouch and a waste compartment is located on the second side of pouch. The pet owner picks up the waste with a disposable bag and places it in the waste compartment for later disposal. The leash pouch is convenient, lightweight, washable and durable. Shortcomings include a leash bag that is relatively bulky, and is not easily accessible.

US20060054107A1 discloses a waste-carrying pouch, for use by pet owners to carry waste (feces) to a trash can or waste basket. The pouch hangs from a leash, near the handle, and can be reversibly opened and closed. An improved design uses a combination of: (i) two attachment points, positioned at the two ends of the pouch, to minimize swinging motion by a pouch loaded with waste, and (ii) walls made of a semi-stiff plastic-impregnated fabric, such as “420D” nylon with a polyvinyl chloride coating, to provide a suitable degree of “stiffening” to make opening and closing the pouch easier and more reliable even when a leash is being jerked and tugged. Pouch-and-leash combinations are also with either standard or retractable leashes, having rings or other coupling devices on the leash, and pouch assortments are disclosed with a range of sizes. Shortcomings include a leash bag that is relatively bulky, and is not easily opened and closed.

U.S. Pat. No. 5,718,192A discloses an animal waste carrying bag and leash for carrying articles such as pet waste, waste retrieval articles, bags, and personal belongings. The carrying bag may be attached to the pet leash or carried by hand. A name plate on the carrying bag provides identification of the owner and a fluorescent strip on the carrying bag provides for safer walking at night. The apparatus allows for a cleaner, more dignified way of transporting pet waste. Shortcomings include a leash bag that is relatively bulky, and is not easily accessible.

US20030111022A1 discloses a pouch for canine excrement which has an elongated mouth for gaining access to the interior of the pouch and a zipper for opening and closing the mouth. One or more cords have loops which extend outwardly from the top of the pouch. A toggle is attached to each cord for increasing and decreasing the size of the loop. The pouch is attached to a leash by first, passing the leash through the opening in each loop and secondly, by tightening the loops around the leash by means of the toggles in order to affix the pouch tightly to the leash so that the pouch does not move on the leash. A cord may also be attached to the handle of the leash should it be difficult to stop the pouch from sliding on the leash. Shortcomings include a leash bag that is relatively bulky, and is not easily opened and closed.

US20170013807A1 discloses a tri-fold bag for containment of items while walking a pet, the tri-fold bag including a collapsible main compartment section made from a water-resistant flexible material having an opening opposite a base with drain holes, and foldable along its length. A cover flap is foldable over the opening for enclosing the main compartment section when open, and foldable over the tri-fold closed configuration. Fastener straps provide for attaching a shoulder strap or a leash to the tri-fold bag during the pet walk. The tri-fold bag includes a plurality of easily accessible secondary compartments for storage of personal items while walking the pet.

USD393504S discloses a design for a pouch for attachment to pet leash.

All documents cited herein are incorporated by reference.

None of the above cited documents, alone or in combination satisfy the need for a universal, compact feces holder configured for releasable attachment to a dog leash, that addresses the above-mentioned deficiencies.

### BRIEF SUMMARY

It is an object of the invention to provide a feces holder configured for universal and releasable attachment to a dog leash and method of use.

A device for containing and attaching bagged feces to a leash, said device comprising: a bag encompassing unit for containing bagged feces, comprising a lid portion and a base portion, said lid portion and base portion are permanently attached to one another at a first edge of said bag encompassing unit, and releasably attached to one another at a second edge of said bag encompassing unit, said base portion further comprising an upper attachment region an lower attachment region, an inner surface and an outer surface; an attachment strap, permanently affixed to a side of the upper attachment region; a leash encompassing strap, comprising a first and a second end, for releasably attaching said bag encompassing unit to a leash handle, said leash encompassing strap being permanently attached at the first end to a side of the upper attachment region opposing said attachment strap, said leash encompassing strap being sized and configured to thread through the leash handle and releasably attach to said attachment strap at said second end; at least one leash securing member, for releasably securing said bag encompassing unit to said leash, the leash securing member having an upper end and a lower end, said upper end permanently attached to a side of the lower attachment region, sized and proportioned to releasably attach to an opposing side of said lower attachment region; and at least one releasable attachment member, comprising an attachment unit on an upper end of said lid portion and an attachment unit on an upper end of said base portion, for releasably attaching said upper end of said lid portion to said upper end of said base portion.

In accordance with an embodiment of the invention, the bag encompassing unit further comprises: a curved indentation unit, located on the outer surface of said base portion being adapted to accommodate said leash; and a hinge member, for permanently connecting a first edge of said lid portion to a first edge of said base portion.

In accordance with an embodiment of the invention, said attachment units comprise one or more magnets.

In accordance with an embodiment of the invention, the bag encompassing unit comprises a rigid material.

In accordance with an embodiment of the invention, said base portion has a generally concave shape which opposes said lid portion.

In accordance with an embodiment of the invention, the leash encompassing strap comprises a bendable flexible material.

In accordance with an embodiment of the invention, said first edge is a lower edge and said second edge is an upper edge.

In accordance with an embodiment of the invention, said first edge is a side edge and said second edge is an opposite side edge.

In accordance with an embodiment of the invention, said lid portion comprises a plurality of ventilation holes.

In accordance with an embodiment of the invention, the lid portion comprising a hole portion at the upper edge of said lid portion.

In accordance with an embodiment of the invention, the lid portion comprises two lip members on opposing sides of the upper edge of said lid portion.

In accordance with an embodiment of the invention, the base portion comprising one or more sets of two slit portions, each slit portion being on opposing sides of said curved indentation unit, said slit portions being sized and proportioned to permanently attach the upper edge of the leash securing member to the lower attachment region, and releasably attach the lower edge of the leash securing member to the lower attachment region.

In accordance with another aspect of the invention there is provided a method of attaching the device, as described above, to the leash, the method comprising threading said leash encompassing strap through the leash handle and releasably attaching said second end of leash encompassing strap to the upper attachment region; aligning said leash with said curved indentation, and securing said leash to the bag encompassing unit by releasably attaching the lower end of one or more leash securing members to the lower attachment region opening the bag encompassing unit; placing bagged feces in between the base portion and the lid portion of said bag encompassing unit; and closing the bag encompassing unit.

In accordance with an embodiment of the invention, the bag encompassing unit is opened by pulling the base portion and the lid portion apart.

In accordance with an embodiment of the invention, the bag encompassing unit is closed by pushing said lid portion towards said base portion.

In accordance with an embodiment of the invention, wherein the attachment unit on the upper edge of said lid portion engages with the attachment unit on the upper edge of said base portion, for releasably attaching said upper edge of said lid portion to said upper edge of said base portion.

In accordance with another aspect of the invention there is provided a universal bagged feces holder which is configured to releasably attach to any leash.

The advantages and features of the present invention will become better understood with reference to the following more detailed description and claims taken in conjunction with the accompanying drawings in which like elements are identified with like symbols.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1 illustrates a top-down view of one aspect of the subject matter in accordance with one embodiment.

FIG. 2 illustrates a top-down view of the subject matter in accordance with one embodiment.

FIG. 3A illustrates top view of the subject matter in accordance with one embodiment.

FIG. 3B illustrates top view of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6A illustrates a top view of an aspect of the subject matter in accordance with one embodiment.

FIG. 6B illustrates a top view of an aspect of the subject matter in accordance with one embodiment.

FIG. 6C illustrates a side view of an aspect of the subject matter in accordance with one embodiment.

FIG. 6D illustrates a side view of an aspect of the subject matter in accordance with one embodiment.

FIG. 7A illustrates a top view of an aspect of the subject matter in accordance with one embodiment.

FIG. 7B illustrates a top view of an aspect of the subject matter in accordance with one embodiment.

FIG. 7C illustrates a side view of an aspect of the subject matter in accordance with one embodiment.

FIG. 7D illustrates a side view of an aspect of the subject matter in accordance with one embodiment.

FIG. 8A illustrates a top view of an aspect of the subject matter in accordance with one embodiment.

FIG. 8B illustrates a top view of an aspect of the subject matter in accordance with one embodiment.

FIG. 8C illustrates a side view of an aspect of the subject matter in accordance with one embodiment.

FIG. 8D illustrates a side view of an aspect of the subject matter in accordance with one embodiment.

FIG. 9A illustrates a side view of the subject matter in accordance with one embodiment.

FIG. 9B illustrates a side view of the subject matter in accordance with one embodiment.

FIG. 10 illustrates an aspect of the subject matter in accordance with one embodiment.

FIG. 11 illustrates an aspect of the subject matter in accordance with one embodiment.

### DETAILED DESCRIPTION

The term “connected”, “attached”, “affixed” or “coupled to” may include both direct coupling (in which two elements that are coupled to each other contact each other) and indirect coupling (in which at least one additional element is located between the two elements).

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

Embodiments of the invention as described relate to the transport of bagged dog feces to a place for disposal. Transporting dog feces is an unpleasant task and the embodiments described herein relate to a discrete and easy to use holder that attaches to the handle of a dog leash.

The invention as described herein includes embodiments of holders or bag encompassing units designed and configured for easy attachment and removal from a dog leash. The holders can be releasably and adjustably secured to the handle of a dog leash at any desired distance for the leash handle. The holders typically comprise a lid portion and a base portion, which may be permanently attached to one another, at one end by a hinge, and releasably attached at another end, preferably, but not necessarily, by one or more magnets.

The holders disclosed may be releasably and adjustably secured to a leash handle with a leash encompassing unit, and releasably and adjustably secured to a leash with one or more leash securing members.

The holders disclosed may generally have a lid portion and a base portion comprising opposing concave outlines, although the shape of the outline may be customizable to a user.

Alternate embodiments of the device may comprise opposing convex sides that come together to form a solid base and top, and have perforated sides for ventilation. The sides comprise an opening through which the bagged dog feces can be inserted into the central cavity of the holder for easy and discrete transportation to a disposal facility, when the bagged feces and easily be removed from the holder.

The alternate embodiment described herein comprises a holder preferably having perforated sides and a slot positioned towards the top of the holder. The holder can be secured onto a dog leash by a strap that loops through the leash handle. The holder is releasably fastened in place by an upper securing member that fastens to an upper attachment region and a lower securing member that attaches to a lower attachment region. Typically, the upper securing member fastens to the upper attachment region by way of a push-fit connection, Similarly, the lower securing member attaches to a lower attachment region by a push-fit connection.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

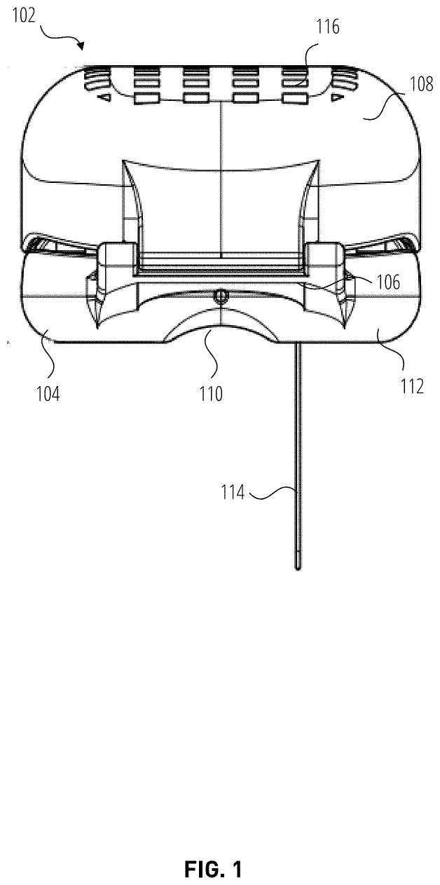

FIG. 1 illustrates a bag encompassing unit 102 of the subject matter in accordance with one embodiment. The bag encompassing unit 102 comprises a base portion 104 and a lid portion 108, which are connected by a hinge 106.

There is a curved indentation unit 110 down the middle of the base portion 104 on the base portion-outer surface 112. A leash preferably aligns with and lays in the curved indentation unit 110. There is at least one, but preferably two, adjustable leash securing members 114, or straps on the base portion 104. The leash may be strapped into the curved indentation unit 110 it was placed into. This will prevent the bag encompassing unit 102 from moving out of place, keeping the bag encompassing unit 102 facing forward, away from a dog walker. The adjustable strap(s) are locked into place inside the bag encompassing unit 102.

The lid portion 108 of the bag encompassing unit 102 preferably comprises a plurality of ventilation holes 116—keeping a dog's used feces bag confined while allowing the odor to leave the bag encompassing unit 102.

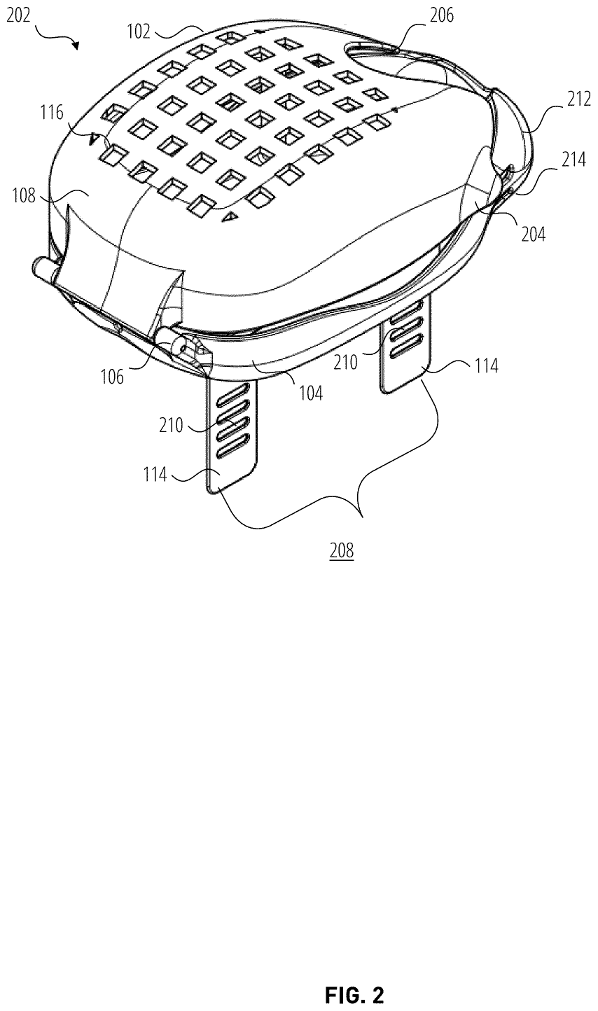

FIG. 2 illustrates a bag encompassing unit: top-down view 202 in accordance with one embodiment.

The bag encompassing unit 102 may be opened by a user by placing a hand on either side of the lid portion 108, gripping the lip members 204, and pulling the lid portion 108 away from the base portion 104.

A dog's used feces bag may then be placed inside the bag encompassing unit 102 by placing it in between the base portion 104 and the lid portion 108. A hole portion 206 allows a tip of a dog feces bag to extend outwards from the bag encompassing unit 102, such that the bag is preferably not compressed when it is contained inside the bag encompassing unit 102.

A plurality of ventilation holes 116 on the lid portion 108 allow for ventilation.

The bag encompassing unit 102 may be closed by pushing the lid portion 108 down towards the base portion 104.

Leash securing members 114 may be attached to the bag encompassing unit 102 at the lower attachment region 208, through strap slits 210.

At an upper attachment region 212 of the base portion 104, attachment slits 214 allow for an additional strap to be attached.

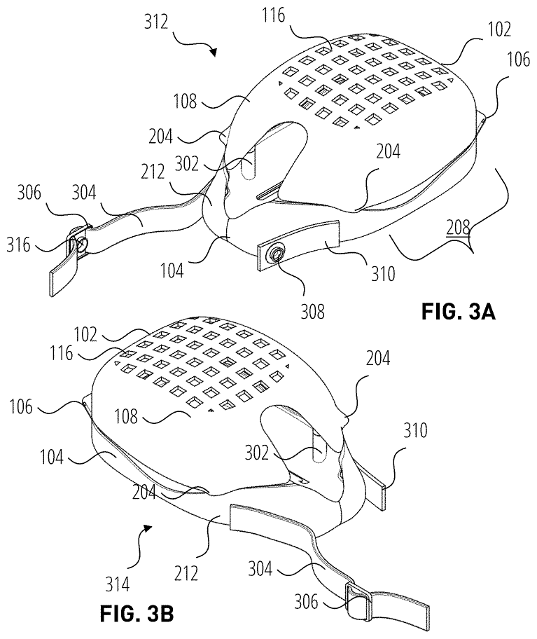

FIG. 3A illustrates a top view 312 of a bag encompassing unit 102 in accordance with one embodiment.

The leash encompassing strap 304 is permanently attached to the upper attachment region 212 of the base portion-outer surface 112 at one end of the leash encompassing strap 304. A leash encompassing strap attachment region 310 is permanently affixed to an opposing side of the upper attachment region 212 of the base portion 104. The leash encompassing strap 304 is threaded through a leash handle, and may be releasably attached to the leash encompassing strap attachment region 310 by connecting the attachment unit male end 316 to the attachment unit female end 308.

The length of the leash encompassing strap 304 may be adjusted by pulling the leash encompassing strap 304 through the strap adjustor 306.

A plurality of ventilation holes 116 on the lid portion 108 allow for ventilation.

A hinge 106 permanently connects the lid portion 108 to the base portion 104 at one end.

Attachment units 302, which preferably comprise one or more magnets, releasably connect the lid portion 108 to the base portion 104 at another end.

Preferably, the attachment units 302 are directly opposite from the hinge 106. This can be achieved by placing the hinge 106 at the lower attachment region 208 and the attachment units 302 at the upper attachment region 212. Alternatively, the hinge 106 and the attachment units 302 may be on opposing sides of either the upper attachment region 212 or the lower attachment region 208.

The bag encompassing unit 102 may be opened by gripping lip members 204 and pulling the lid portion 108 away from the base portion 104.

FIG. 3B illustrates a top view, rotated 314 of a bag encompassing unit 102 in accordance with one embodiment.

The length of the leash encompassing strap 304 may be adjusted by pulling the leash encompassing strap 304 through the strap adjustor 306.

A plurality of ventilation holes 116 on the lid portion 108 allow for ventilation.

A hinge 106 permanently connects the lid portion 108 to the base portion 104 at one end.

Attachment units 302, which preferably comprise one or more magnets, releasably connect the lid portion 108 to the base portion 104 at another end.

The bag encompassing unit 102 may be opened by gripping lip members 204 and pulling the lid portion 108 away from the base portion 104.

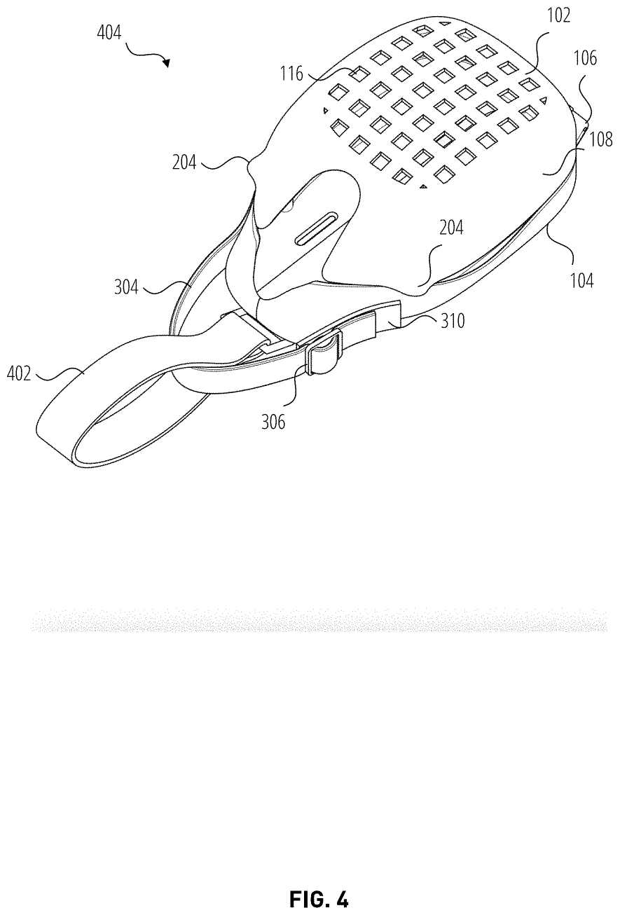

FIG. 4 illustrates a of a top view 404 of a bag encompassing unit 102.

The leash encompassing strap 304 may be threaded through a leash handle 402 and releasably secured to the leash encompassing strap attachment region 310.

The length of the leash encompassing strap 304 may be adjusted by pulling the leash encompassing strap 304 through the strap adjustor 306.

A plurality of ventilation holes 116 on the lid portion 108 allow for ventilation.

A hinge 106 permanently connects the lid portion 108 to the base portion 104 at one end.

The bag encompassing unit 102 may be opened by gripping lip members 204 and pulling the lid portion 108 away from the base portion 104.

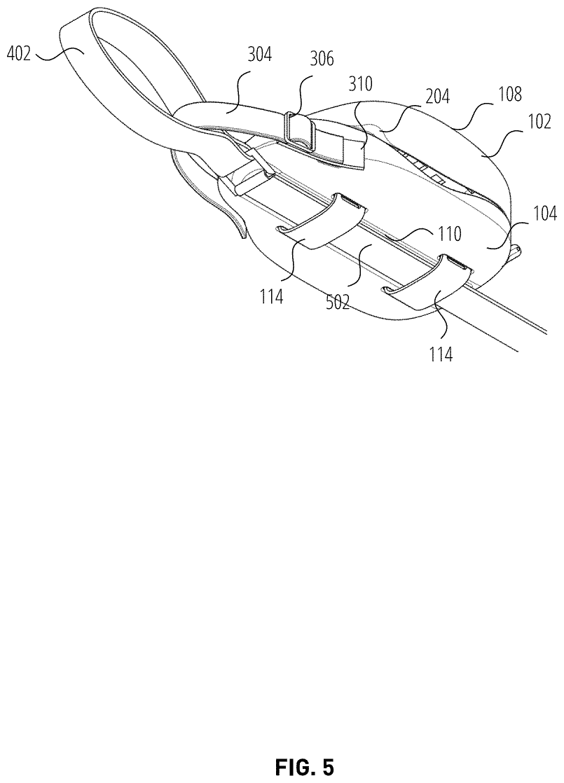

FIG. 5 illustrates a bottom-up view of a bag encompassing unit 102. The leash encompassing strap 304 may be threaded through a leash handle 402 and releasably secured to the leash encompassing strap attachment region 310.

The length of the leash encompassing strap 304 may be adjusted by pulling the leash encompassing strap 304 through the strap adjustor 306.

A leash strap 502 is aligned with the curved indentation unit 110, covering it, and secured to the base portion 104 with at least one leash securing member 114.

The bag encompassing unit 102 may be opened by gripping lip members 204 and pulling the lid portion 108 away from the base portion 104.

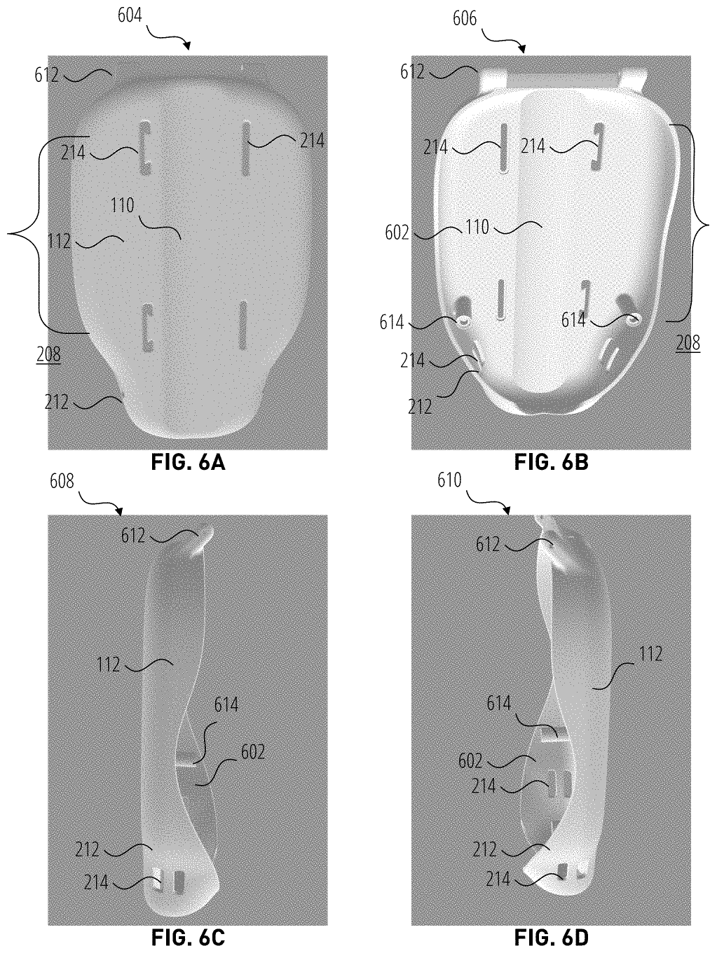

FIG. 6A illustrates a top view 604 of the base portion-outer surface 112. Base portion hinge 612 preferably permanently attaches, at one end, the base portion 104 to the lid portion 108.

Attachment slits 214 at the lower attachment region 208 affix an end of a leash securing member 114 to the base portion 104.

An upper attachment region 212 may be used to attach a leash encompassing unit to the base portion 104. A leash may rest inside of curved indentation unit 110.

FIG. 6B illustrates a top view 606 of the base portion-inner surface 602. Magnets 614 may releasably connect an end of the base portion 104 to an end of the lid portion 108.

Base portion hinge 612 preferably permanently attaches, at one end, the base portion 104 to the lid portion 108.

Attachment slits 214 at the upper attachment region 212 may be used to attach a leash encompassing unit to the base portion 104.

Attachment slits 214 at the lower attachment region 208 affix an end of a leash securing member 114 to the base portion 104.

FIG. 6C illustrates a side view 608 of the base portion-inner surface 602 and base portion-outer surface 112.

FIG. 6D illustrates a side view 610 of the base portion-inner surface 602 and base portion-outer surface 112.

Attachment slits 214 at the upper attachment region 212 may be used to attach a leash encompassing unit to the base portion 104.

Magnets 614 may releasably connect an end of the base portion 104 to an end of the lid portion 108.

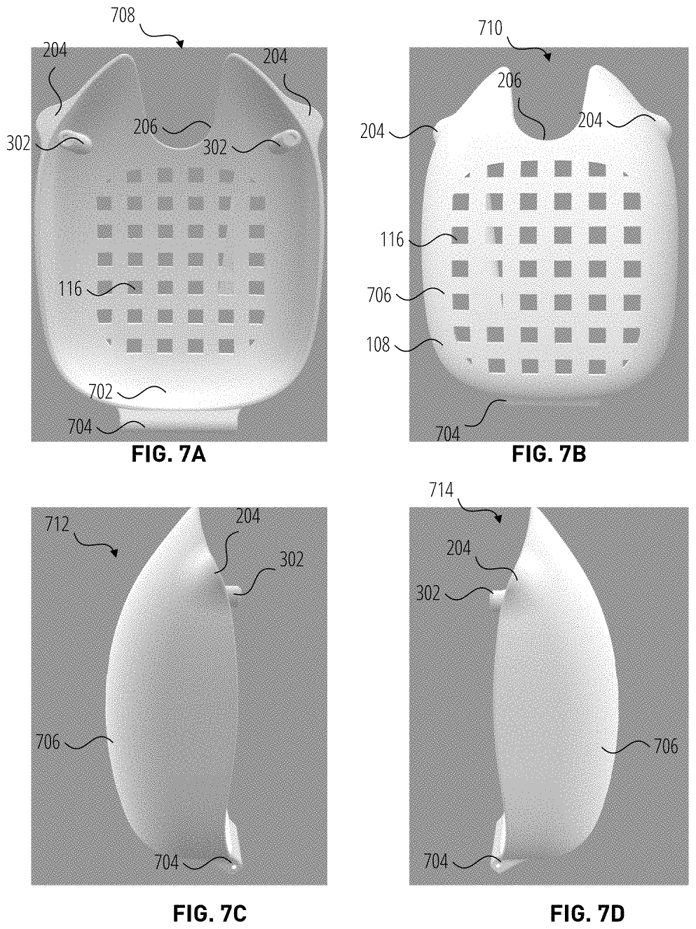

FIG. 7A illustrates a top view 708 of a lid portion-inner surface 702.

Lip members 204 allow for a user to pull the lid portion 108 away from the base portion 104 to open the bag encompassing unit 102.

A hole portion 206 allows for a tip of a bag to stick out of the lid portion 108.

The lid portion hinge 704 attaches to the base portion hinge 612 to permanently attach the lid portion 108 to the base portion 104 at one end.

The attachment units 302, which preferably comprise magnets, releasably attach the lid portion 108 to the base portion 104.

FIG. 7B illustrates a top view 710 of a lid portion-outer surface 706. A plurality of ventilation holes 116 acts as ventilation.

Lip members 204 allow for a user to pull the lid portion 108 away from the base portion 104 to open the bag encompassing unit 102.

The attachment units 302, which preferably comprise magnets, releasably attach the lid portion 108 to the base portion 104.

FIG. 7C illustrates a side view 712 of a lid portion-outer surface 706.

Lip members 204 allow for a user to pull the lid portion 108 away from the base portion 104 to open the bag encompassing unit 102.

The attachment units 302, which preferably comprise magnets, releasably attach the lid portion 108 to the base portion 104.

The lid portion hinge 704 attaches to the base portion hinge 612 to permanently attach the lid portion 108 to the base portion 104 at one end.

FIG. 7D illustrates a side view 714 of a lid portion-outer surface 706.

Lip members 204 allow for a user to pull the lid portion 108 away from the base portion 104 to open the bag encompassing unit 102.

The attachment units 302, which preferably comprise magnets, releasably attach the lid portion 108 to the base portion 104.

The lid portion hinge 704 attaches to the base portion hinge 612 to permanently attach the lid portion 108 to the base portion 104 at one end.

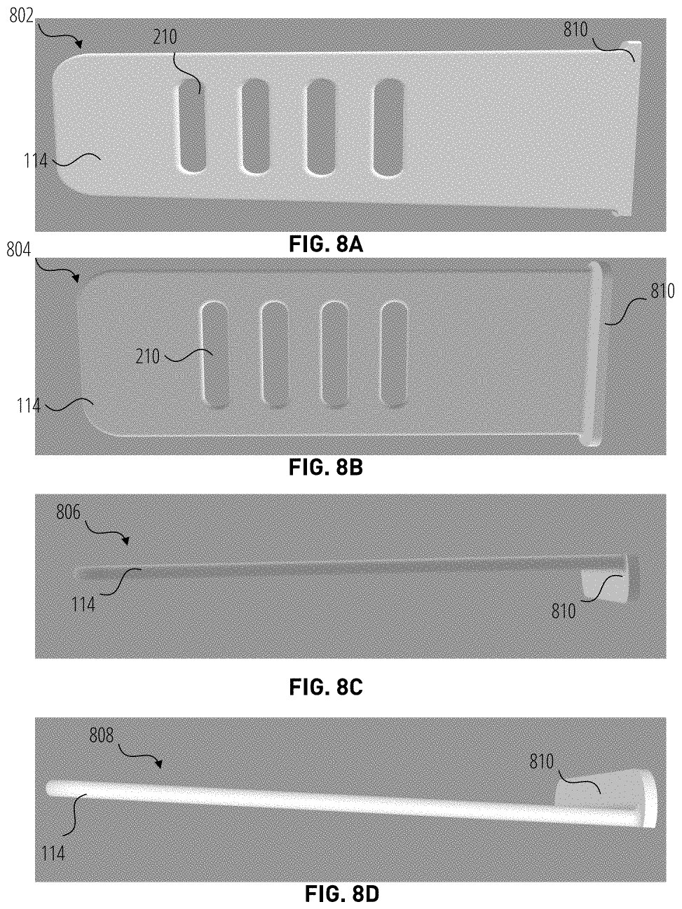

FIG. 8A illustrates a top view 802 of a leash securing member 114.

A leash strap upper end 810 may permanently affix the leash securing member 114 to the attachment slits 214 of the lower attachment region 208 of the base portion 104 of the bag encompassing unit 102.

The strap slits 210 may adjustably and releasably attach the leash securing member to the attachment slits 214 of the lower attachment region 208 of the base portion 104 of the bag encompassing unit 102.

FIG. 8B illustrates a top view 804 of a leash securing member 114.

A leash strap upper end 810 may permanently affix the leash securing member 114 to the attachment slits 214 of the lower attachment region 208 of the base portion 104 of the bag encompassing unit 102.

The strap slits 210 may adjustably and releasably attach the leash securing member to the attachment slits 214 of the lower attachment region 208 of the base portion 104 of the bag encompassing unit 102.

FIG. 8C illustrates a side view 806 of a leash securing member 114.

The leash strap upper end 810 permanently affixes the leash securing member 114 to the base portion 104 of the bag encompassing unit 102.

FIG. 8D illustrates a side view 808 of a leash securing member 114.

The leash strap upper end 810 permanently affixes the leash securing member 114 to the base portion 104 of the bag encompassing unit 102.

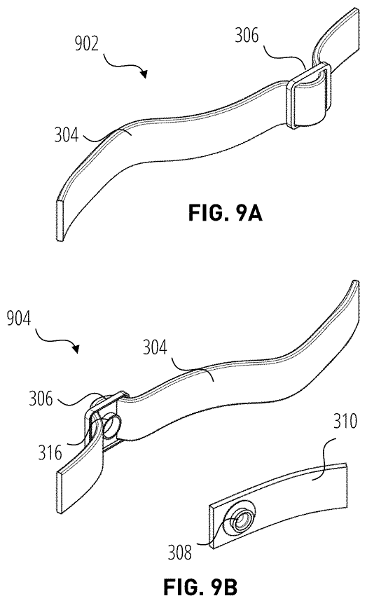

FIG. 9A illustrates a leash encompassing strap-side view 902. The leash encompassing strap 304 may be threaded through a leash handle.

The length of the leash encompassing strap 304 may be adjusted by pulling it through the strap adjustor 306.

FIG. 9B illustrates a leash encompassing strap, rotated 904.

The attachment unit male end 316 may be releasably attached to the attachment unit female end 308 so that one end of the leash encompassing strap 304 is releasably attached to the leash encompassing strap attachment region 310.

The length of the leash encompassing strap 304 may be adjusted by pulling it through the strap adjustor 306.

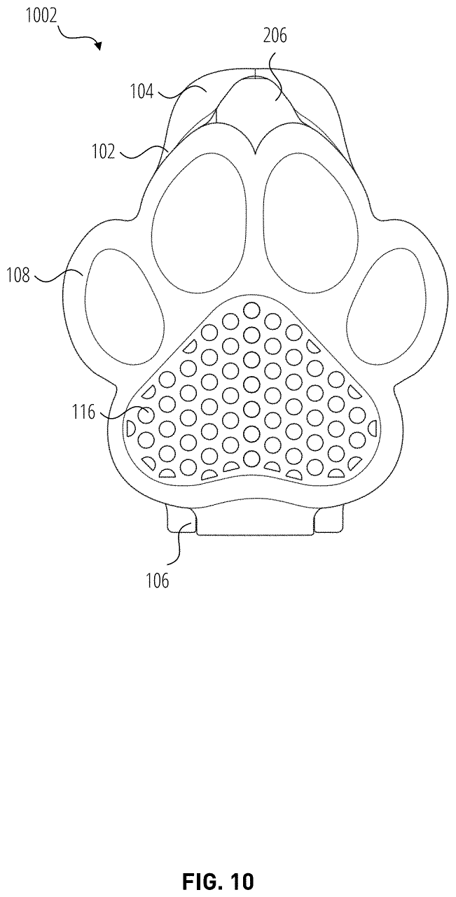

FIG. 10 illustrates a bag encompassing unit alternate embodiment 1002 of the present invention. In the illustrated embodiment, it can be seen that the lid portion 108 may have various shapes, customizable to the user-for example, a paw print in the present depiction.

A plurality of ventilation holes 116 are preferably present in the lid portion 108 for ventilation, and a hole portion 206 allows the tip of a bag of dog feces to extend outwards so that it is not compressed when contained in the bag encompassing unit 102.

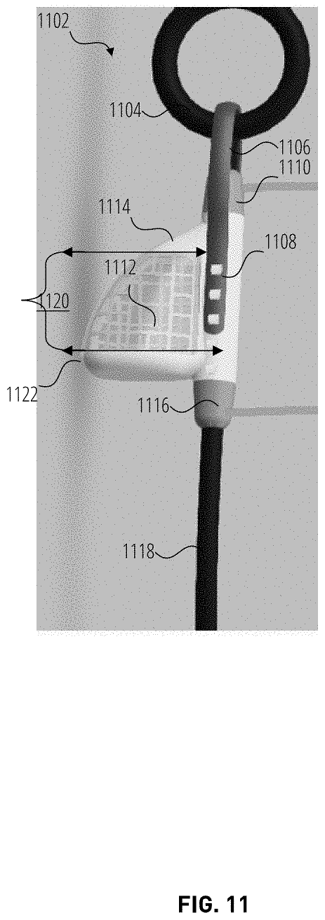

FIG. 11 illustrates an alternate embodiment 1102 of the present invention. In the illustrated embodiment, a holder 1122, preferably having perforated sides 1112, and a slot 1114 positioned towards the top of the holder 1122. The holder 1122 can be secured onto a leash 1118 by a strap 1106, which loops through the leash handle 1104. The holder 1122 is releasably fastened in place by an upper securing member 1110. Typically, the upper securing member 1110 attaches to the holder 1122 by way of a push-fit connection. A section of one of the perforated sides 1112 has an opening 1120, which allows for the insertion of a bag containing feces. A releasable fastener 1108 may releasably attach the upper securing member 1110 to the holder 1122.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The embodiments of the devices disclosed can be fabricated from a variety of common components, although typically plastics are well suited for these products. The plastics may be 3D printed, injection molded or extruded. An example of 3D printable plastics includes polylactic acid, or PLA, this material has the benefit of being biodegradable as it is manufactured using renewable raw materials such as corn starch. ABS filament another type of 3D printing thermoplastic which contains a base of elastomers based on polybutadiene, making it more flexible, and resistant to shocks. ASA is a material that has similar properties to ABS, but has a greater resistance to UV rays. Polyethylene terephthalate, or PET, is ideal for fabricating larger more rigid frames. PETG, is a glycolyzed PET polymer that combines both the simplicity of PLA 3D printing and the strength of ABS, and it is 100% recyclable. Numerous other 3D printable polymers, hybrids and composites are known and considered to be within the scope of protection sought. Plastics that are particularly suitable for injection molding include Nylon™, acrylics, which are particularly suitable for being tinted, polycarbonate (PC), polyoxymethylene (POM), polystyrene (PS), acrylonitrile butadiene styrene (ABS), polypropylene (PP), polyethylene (PE), thermoplastic polyurethane (TPU), and thermoplastic rubber (TPR). Plastics that are particularly suitable for extrusion include polyethylene (PE), polypropylene, acetal, acrylic, nylon (polyamides), polystyrene, polyvinyl chloride (PVC), acrylonitrile butadiene styrene (ABS) and polycarbonate.

Flexible materials, for example, but not limited to, rubber, PP, PE, acrylic, biothane, and fabrics, may be used for fabricating bendable, flexible straps.

Other devices may be made from washable fabric materials and be secured in place using hook and loop type fasteners including Velcro™. Zippers may be attached to the fabric in order to open and close the opening into the body of the holder.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A device for containing and attaching bagged feces to a leash, said device comprising:
a bag encompassing unit for containing bagged feces, comprising a lid portion and a base portion, said lid portion and base portion are permanently attached to one another at a first edge of said bag encompassing unit, and releasably attached to one another at a second edge of said bag encompassing unit, said base portion further comprising an upper attachment region, a lower attachment region, an inner surface and an outer surface;
an attachment strap, permanently affixed to a side of the upper attachment region;
a leash encompassing strap, comprising a first and a second end, for releasably attaching said bag encompassing unit to a leash handle, said leash encompassing strap being permanently attached at the first end to a side of the upper attachment region opposing said attachment strap, said leash encompassing strap being sized and configured to thread through the leash handle and releasably attach to said attachment strap at said second end;
at least one leash securing member, for releasably securing said bag encompassing unit to said leash, the leash securing member having an upper end and a lower end, said upper end permanently attached to a side of the lower attachment region, sized and proportioned to releasably attach to an opposing side of said lower attachment region; and
at least one releasable attachment member, comprising an attachment unit on an upper end of said lid portion and an attachment unit on an upper end of said base portion, for releasably attaching said upper end of said lid portion to said upper end of said base portion.

2. The device of claim 1, wherein said bag encompassing unit further comprises:
a curved indentation unit, located on the outer surface of said base portion being adapted to accommodate said leash; and
a hinge member, for permanently connecting a lower end of said lid portion to a lower end of said base portion.

3. The device of claim 1, wherein said attachment units comprise one or more magnets.

4. The device of claim 1, wherein said bag encompassing unit comprises a rigid material.

5. The device of claim 1, wherein said lid portion has a generally concave shape.

6. The device of claim 1, wherein said base portion has a generally concave shape which opposes said lid portion.

7. The device of claim 1, wherein the leash encompassing strap comprises a bendable flexible material.

8. The device of claim 1, wherein said first edge is a lower edge and said second edge is an upper edge.

9. The device of claim 1, wherein said first edge is a side edge and said second edge is an opposite side edge

10. The device of claim 2, wherein said lid portion comprises a plurality of ventilation holes.

11. The device of claim 2, wherein the lid portion comprises a hole portion at the upper edge of said lid portion.

12. The device of claim 2, wherein the lid portion comprises two lip members on opposing sides of the upper edge of said lid portion.

13. The device of claim 2, wherein the base portion further comprises one or more sets of two slit portions, each slit portion being on opposing sides of said curved indentation unit, said slit portions being sized and proportioned to permanently attach the upper end of the leash securing member to the lower attachment region, and releasably attach the lower end of the leash securing member to the lower attachment region.

14. A method of attaching the device of claim 1 to the leash, the method comprising:
threading said leash encompassing strap through the leash handle and releasably attaching said second end of leash encompassing strap to the upper attachment region;
aligning said leash with said curved indentation, and securing said leash to the bag encompassing unit by releasably attaching the lower end of one or more leash securing members to the lower attachment region;
opening the bag encompassing unit;
placing bagged feces in between the base portion and the lid portion of said bag encompassing unit; and
closing the bag encompassing unit.

15. The method of claim 14, wherein the bag encompassing unit is opened by pulling the base portion and the lid portion apart.

16. The method of claim 14, wherein the bag encompassing unit is closed by pushing said lid portion towards said base portion.

17. The method of claim 14, wherein the attachment unit on the upper edge of said lid portion engages with the attachment unit on the upper edge of said base portion, for releasably attaching said upper edge of said lid portion to said upper edge of said base portion.
